(19) United States
(12) Patent Application Publication
(10) Pub. No.: US 2021/0182054 A1
(43) Pub. Date: Jun. 17, 2021

(54) PREVENTING UNEXPECTED BEHAVIOR IN SOFTWARE SYSTEMS DUE TO THIRD PARTY ARTIFACTS

(71) Applicant: Intuit Inc., Mountain View, CA (US)

(72) Inventor: Michael Kalika, Rishon Le-Tzion (IL)

(73) Assignee: Intuit Inc., Mountain View, CA (US)

(21) Appl. No.: 16/715,632

(22) Filed: Dec. 16, 2019

(51) Int. Cl. G06F 8/71; G06F 8/65; G06F 11/36; G06F 8/41

(52) U.S. Cl. CPC G06F 8/71; G06F 8/433; G06F 11/3688; G06F 8/65

(57) ABSTRACT

A method including executing a software application in an enterprise environment. The software application interacts with an artifact as part of execution of the software application. The method also includes receiving an updated artifact for the software application at a source control system. The updated artifact comprises an updated dependency endpoint. The updated artifact is published by a third party. The method also includes adjusting the updated dependency endpoint for the updated artifact to a revised dependency endpoint that refers to the source control system. The method also includes testing operation of the software application with the revised artifact in a testing environment for the enterprise environment. The revised artifact has the revised dependency endpoint during testing. Testing is performed against a benchmark. The method also includes deploying, responsive to testing passing the benchmark, the revised artifact with the revised dependency endpoint to the software application in the enterprise environment.

### BACKGROUND

When creating software, such as web applications, developers sometimes experience the use of third party artifacts. An artifact is an aspect of a computer program or a reference to data or a library. Examples of artifacts include libraries or components provided by third party providers. An example of a component is a user interface element such as a “grid” and an example of a library is a dynamically referenced code library file, which could be written in JAVASCRIPT®. However, when updated, third party artifacts may cause unexpected behavior in an enterprise environment.

### SUMMARY

In part, the one or more embodiments are directed to a method. The method includes executing a software application in an enterprise environment. The software application interacts with an artifact as part of execution of the software application. The method also includes receiving an updated artifact for the software application at a source control system. The updated artifact comprises an updated dependency endpoint. The updated artifact is published by a third party. The method also includes adjusting the updated dependency endpoint for the updated artifact to a revised dependency endpoint that refers to the source control system. The method also includes testing operation of the software application with the revised artifact in a testing environment for the enterprise environment. The revised artifact has the revised dependency endpoint during testing. Testing is performed against a benchmark. The method also includes deploying, responsive to testing passing the benchmark, the revised artifact with the revised dependency endpoint to the software application in the enterprise environment.

The one or more embodiments are also directed, in part to a system. The system includes a data repository storing an artifact with which a software application is programmed to interact, wherein the artifact comprises an initial dependency endpoint. The data repository also stores an updated artifact, having an updated dependency endpoint, received from a third party. The data repository also stores a revised artifact comprising the updated artifact having a revised dependency endpoint. The data repository also stores a benchmark. The system also includes an enterprise environment in which the software application is executable. The system also includes a source control system. The source control system is configured to receive the updated artifact at the source control system. The source control system is also configured to adjust the updated dependency endpoint to the revised dependency endpoint to point to the source control system, in order to form the revised artifact. The source control system is also configured to test operation of the software application with the revised artifact in a testing environment for the enterprise environment. The source control system is also configured to deploy, responsive to testing passing the benchmark, the revised artifact to the software application in the enterprise environment.

The one or more embodiments are also directed to an alternative method. The alternative method includes executing a software application in an enterprise environment. The software application interacts with an artifact as part of execution of the software application. The method also includes registering the artifact with a tracking service. The method also includes tracking a third party web page for an update to the artifact published by a third party. The method also includes receiving, responsive to identifying the update, an updated artifact for the software application, wherein the updated artifact comprises an updated dependency endpoint. The method also includes validating the updated artifact. The method also includes adjusting, responsive to validating, the updated dependency endpoint for the updated artifact to a revised dependency endpoint that refers to a source control system. The method also includes testing operation of the software application with the revised artifact in a testing environment for the enterprise environment. The revised artifact has the revised dependency endpoint during testing. Testing is performed against a benchmark. The method also includes deploying, responsive to testing passing the benchmark, the revised artifact with the revised dependency endpoint to the software application in the enterprise environment.

Other aspects of the invention will be apparent from the following description and the appended claims.

### BRIEF DESCRIPTION OF DRAWINGS

FIG. 1 is a block diagram showing how a web application with a third party artifact may result in unexpected behavior in an enterprise environment.

FIG. 2 is a system for preventing unexpected behavior in an enterprise environment due to an update to a third party artifact.

FIG. 3 is a method for preventing unexpected behavior in an enterprise environment due to an update to a third party artifact.

FIG. 4 is another method for preventing unexpected behavior in an enterprise environment due to an update to a third party artifact.

FIG. 5 is another system for preventing unexpected behavior in an enterprise environment due to an update to a third party artifact.

FIG. 6 is an example of preventing unexpected behavior in an enterprise environment due to an update to a third party artifact.

FIG. 7A and FIG. 7B show a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to preventing third party artifacts from causing unexpected behavior in software systems, particularly in enterprise environments. As indicated above, an artifact is an aspect of a computer program or a reference to data or a library. Examples of artifacts include libraries or components provided by third party providers. An example of a component is a user interface element such as a “grid” and an example of a library is a dynamically referenced code library file, which could be written in JAVASCRIPT®.

While use of third party artifacts in generating web applications for enterprise systems may be common, unregulated updates to the artifacts generated by third party entities may result in unexpected behavior by the enterprise environment. Thus, the one or more embodiments provide for controlling whether, when, and/or how third party updates to artifacts are allowed to be deployed to corresponding web applications in the enterprise environment. Briefly, a validation system initially may verify that an artifact update is valid. After validation, a source control system may be used to control whether, when, and/or how third party updates to artifacts may be deployed to the enterprise environment. Dependencies of the updated artifacts are changed from the dependencies originally specified in updated artifacts to the source control system. If necessary or desirable, additional local modifications may be made to the updated artifact. In either case, a revised artifact is generated that, at a minimum, has local dependencies changed to the source control system. The revised artifact then may be tested in an integrated development environment (i.e., a test bed) of the enterprise environment. Once performance of the revised artifact passes a benchmark, the revised artifact may be deployed to the corresponding web applications(s) in the enterprise environment.

The one or more embodiments may also be understood by way of example. When writing web applications, developers generally consider usage of third-party, client side libraries or services such as JAVASCRIPT® and TYPESCRIPT®. Some dependencies are not part of the web application project build and deployment package (i.e., the client). The dependencies may be consumed dynamically by the client from a content delivery network or a web host. For example, see https://segment.com, https://amplitude.com, and many others. When such a dynamic dependency is imported into a project, the developer may give giving a “stranger” the privilege of installing and bundling the artifact into that project. The privilege is not to be underestimated. The imported library might be either malicious or the privilege can negatively impact application performance.

In other words, the one or more embodiments address the technical challenge of addressing unexpected behavior of an application or enterprise caused by third-party dependencies introduced by third-party updates. The one or more embodiments address this challenge by performing dependency testing in the embodiments described below.

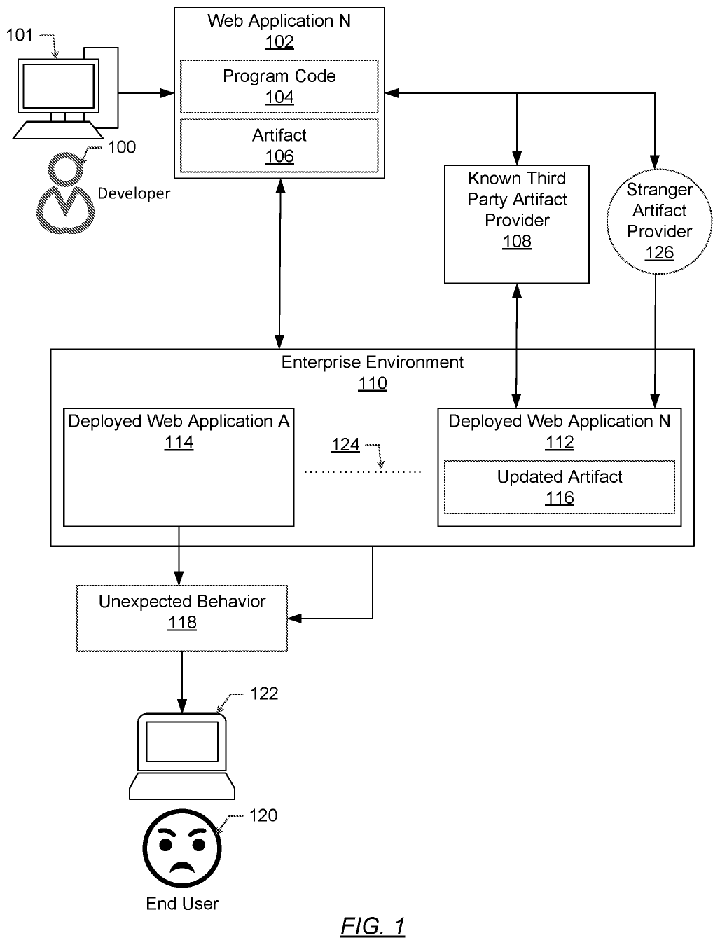

FIG. 1 is a block diagram showing how a web application with a third party artifact may result in unexpected behavior in an enterprise environment. In this example, one or more developers, such as developer (100) generate one or more web applications, such as web application N (102). For purposes of this illustration, only one developer (100) and one web application under development will be discussed for the sake for clarity, though it is assumed that in a real enterprise environment, hundreds or thousands of developers will work with many web applications. It is assumed that the developer (100) is using a computer (101) to perform coding and web application development.

The web application N (102) is defined by program code (104). When executed the program code (104) will perform some function, such as to process a transaction, calculate a value, receive and store customer information, etc. The web application N (102) may also include one or more artifacts, such as artifact (106). Again, an artifact (106) is an aspect of a computer program, or a reference to data or a library, as described above. Examples of artifacts include libraries or components provided by third party providers. An example of a component is a user interface element such as a “grid” and an example of a library is a dynamically referenced code library file, which could be written in JAVASCRIPT®.

The artifact (106) may have been generated by the developer (100). However, in some cases the developer (100) may save significant time by using an existing artifact (106) developed or created by a third party. Thus, for example, the artifact (106) used by or referred-to by the web application N (102) may have been developed by a known third party artifact provider (108).

A “third party,” as used herein, refers to a person, business, organization, or automatic software or hardware that generates artifacts; however, the “third party” is different than and not under the control of the entity or persons that control the enterprise environment (110). As used herein, unless explicitly stated otherwise, the term “third party” also contemplates a “stranger artifact provider” (126), as defined below.

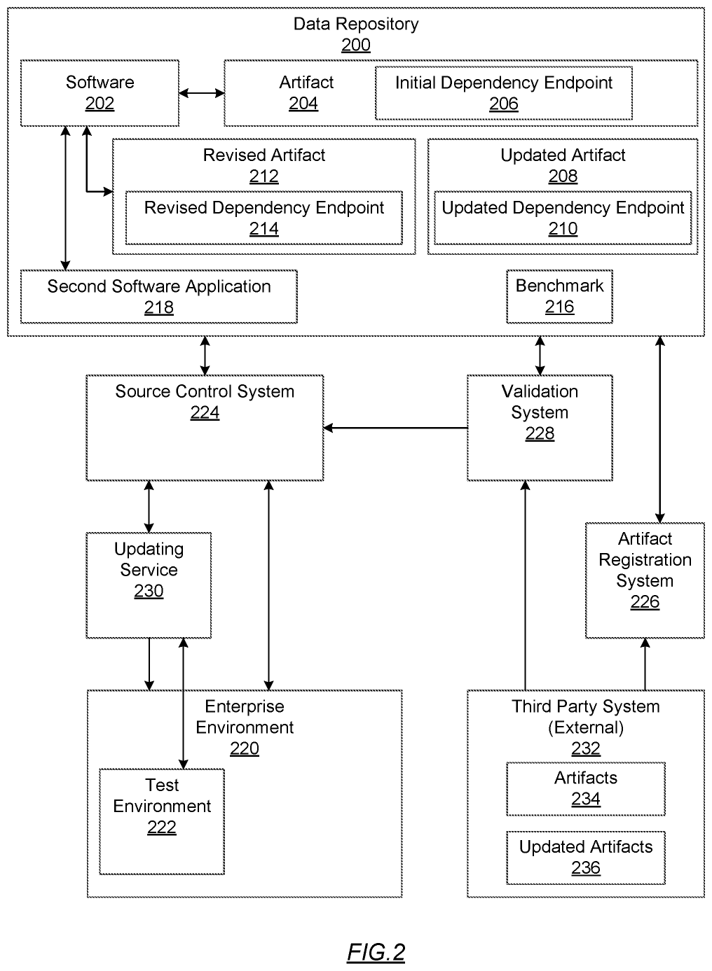

After suitable testing, the web application N (102), together with the artifact (106), is deployed to an enterprise environment (110). Once deployed, the web application may be referred to as deployed web application N (112). The term “enterprise environment” (110) is defined with respect to FIG. 2.

Thus, for example, the enterprise environment (110) in FIG. 1 includes the deployed web application N (112), together with deployed web application A (114). The dotted line (124) indicates the possibility that many additional web applications may be present.

In some cases, the third party artifact (106) may have one or more dependencies. A dependency, generally, is a reference (e.g. a uniform resource locator (URL)) designating where the artifact (106) can be accessed by a client application. An artifact (106) or software application may have multiple dependency endpoints in order to make the artifact (106) or software application available using different protocols. A dependency may also be a reference to some other software program, data, or library not directly related to the web application N (102). When initially developed, the developer (100) may take into account such dependencies used by the artifact (106) during execution of the program code (104). Thus, the deployed web application N (112) is expected to behave as desired when operating in the enterprise environment (110).

However, the artifact (106) may be updated on a regular basis by the known third party artifact provider (108). The artifact (106) so updated may be referred to as an updated artifact (116). The updated artifact (116) may cause technical difficulties for the enterprise environment (110), as described in further detail below.

In some cases, the updated artifact (116) may be automatically downloaded and/or are referred-to by the deployed web application N (112) in the enterprise environment (110). However, the updated artifact (116) may have changed dependencies relative to the initial dependencies specified for the artifact (106). Additionally, the updated artifact (116) may change the behavior of the deployed web application N (112) when referred-to or executed by the program code (104).

Yet further, the updates to the artifact in the deployed web application N (112) may have a ripple effect. A ripple effect occurs when changes to one web application results in a change in how another web application behaves in the enterprise environment (110). For example, the output of deployed web application A (114) may change because of how the updated artifact (116) changes the behavior of the deployed web application N (112).

Thus, there are several possible scenarios in which deployment of the updated artifact (116) may result in unexpected behavior (118) of the enterprise environment (110). The unexpected behavior (118) may be an error in output of the enterprise environment (110), an error in how data is received or handled in the enterprise environment (110), or an error in operation of a specific web application (either deployed web application A (114) or deployed web application N (112)). The unexpected behavior (118) of the enterprise environment (110) may manifest as a slow-down of speed of operation of the enterprise environment (110). Potentially, the updated artifact (116) might cause the entire enterprise environment (110) to behave unexpectedly or to crash.

In another scenario, a stranger may provide an artifact (106), or an updated artifact (116), such as stranger artifact provider (126). The stranger artifact provider (126) may be a malicious actor. For example, the stranger artifact provider (126) may deliberately insinuate an undesirable updated artifact (116) so that the deployed web application N (112) releases sensitive information to the malicious actor, behaves abnormally, is held hostage by the malicious actor, or crashes. The updated artifact (116) insinuated by the stranger artifact provider (126) may be designed to steal personal information of the customers from the enterprise environment (110), in the hopes of committing some other crime with such information. Even when the stranger artifact provider (126) is not malicious, the updated artifact (116) provided by the stranger artifact provider (126) may have errors or may not be subjected to the same quality controls that the known third party artifact provider (108) applies when generating the updated artifact (116).

To help illustrate the technical challenge, the following specific examples of unexpected behavior of the enterprise environment (110) may occur. For example, the invocation of untested or unscanned third party JAVASCRIPT® code in a web application may lead to the loss of control over changes to a client application in the enterprise environment (110). Furthermore, such invocation may lead to the execution of arbitrary, unknown code on client systems in the enterprise environment (110). Such invocation may also result in the disclosure or leakage of sensitive information by the enterprise environment (110). Such invocation may also result in performance degradation of the enterprise environment (110).

In any case, the unexpected behavior (118) of the enterprise environment (110) caused by the updated artifact (116) may manifest as errors, irregularities, or delays that an end user (120) at a user computer (122) may perceive as frustrating. Frustrations by one or more end users may result in overly burdening customer service of the company that maintains the enterprise environment (110), loss of customers, and possibly other undesirable problems.

On the other hand, as indicated above, updates to artifacts may be common and expected. Indeed, in some cases an update to an artifact may be desirable to increase security so that the stranger artifact provider (126) is less likely or less able to introduce a malicious update. Furthermore, standards or programs may change over time. For example, the web application N (102) may evolve over time and require a different artifact than artifact (106), or perhaps an additional artifact. Thus, in most cases, it is expected that many if not most of the web applications in the enterprise environment (110) will be updated with updated artifacts on a regular basis.

Therefore, a desire may exist to provide regular updates to artifacts to software in an enterprise environment, but a desire may also exist to ensure that the updated artifacts do not cause the unexpected behavior (118) of the enterprise environment (110). When the enterprise environment (110) is large, such as in the case of a nationwide commercial enterprise, manually checking or testing the impacts of updated artifacts on the enterprise environment (110) may be impracticable, too expensive, or impossible. For this reason, it may be deemed necessary or desirable to automate the distribution of the updated artifact (116) to one or more web applications in the enterprise environment (110). Thus, a technical issue may exist regarding how to automatically deploy the updated artifact (116) to the enterprise environment (110), while still ensuring that the unexpected behavior (118) of the enterprise environment (110) does not arise.

FIG. 2 is a system for preventing unexpected behavior in an enterprise environment due to an update to a third party artifact. The system shown in FIG. 2 may be one method for increasing the automation used in deploying updated artifacts to an enterprise system, as described with respect to FIG. 1. In one embodiment, the system shown in FIG. 2 may be entirely automated. In another embodiment, the system shown in FIG. 2 may still be subjected to manual checks or authorizations.

In one or more embodiments of the invention, the data repository (200) is any type of storage unit and/or device (e.g., a file system, database, collection of tables, or any other storage mechanism) for storing data. Further, the data repository (200) may include multiple different storage units and/or devices. The multiple different storage units and/or devices may or may not be of the same type or located at the same physical site.

The data repository (200) stores software (202). The software (202) is executable to perform a function on a computer. The software (202) may be a web application, or may be some other software. Thus, the software (202) may be a purely server-side application, though the software (202) may be a client-side application that interacts with an enterprise in some way.

The software (202) includes, refers to, relies on, or otherwise interacts with an artifact (204). Again, the artifact (204) is an aspect of a computer program, or a reference to data or a library, as described above.

The artifact (204) includes an initial dependency endpoint (206). A dependency endpoint, generally, is a reference (e.g. a uniform resource locator (URL)) designating where the artifact (204) can be accessed by a client application. An artifact (204) or software application may have multiple dependency endpoints in order to make the artifact (204) or software application available using different protocols. In this example, the initial dependency endpoint (206) is the dependency endpoint that is provided for the artifact (204) prior to being updated. The initial dependency endpoint (206) need not be the dependency endpoint initially created by a third party provider but may be a dependency endpoint customized for use by the artifact (204) when utilized by the software (202).

The data repository (200) also includes an updated artifact (208). The updated artifact (208) is an artifact that has been updated by a third party. For example, the third party may intend that the artifact (204) be updated to conform to the updated artifact (208). The update may take the form of replacing the artifact (204) with the updated artifact (208).

Because the third party provider will have designated its own dependency endpoint, the updated dependency endpoint (210) of the updated artifact (208) may not be the same as the initial dependency endpoint (206). Indeed, it is anticipated that in many cases, the updated dependency endpoint (210) is not the same as the initial dependency endpoint (206). The updated dependency endpoint (210) may refer, for example, to a website or other resource belonging to the third party provider.

The term “updated dependency endpoint” (210) does not necessarily mean that the dependency endpoint specified for the updated artifact (208) has changed relative to the dependency endpoint specified for the initial dependency endpoint (206). In some cases, the dependency endpoint does not change, but other aspects of the updated artifact (208) are different relative to the artifact (204). However, in order to maintain clear nomenclature, the term “updated dependency endpoint” (210) is used to distinguish the dependency endpoint of the updated artifact (208) from the dependency endpoint in the artifact (204).

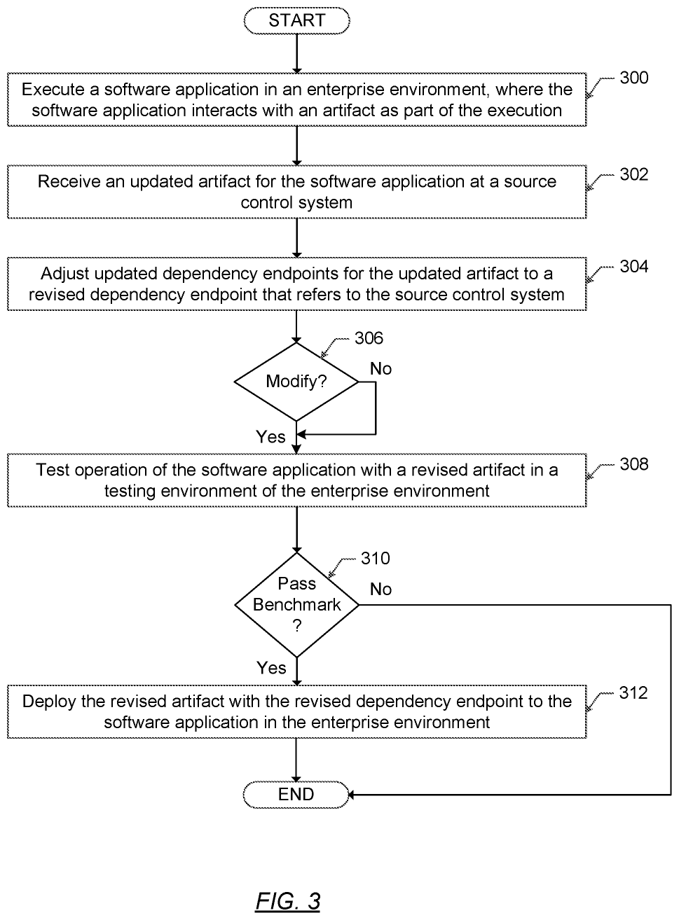

The data repository (200) also stores a revised artifact (212). The revised artifact (212) is the updated artifact (208) after the procedures described with respect to FIG. 3 have been performed with respect to the updated artifact (208). Thus, the revised artifact (212) is different than the updated artifact (208). The revised artifact (212) is modified by the owner or operator of the enterprise environment (220), as defined further below.

The revised artifact (212) has a revised dependency endpoint (214). The revised dependency endpoint (214) is an endpoint, but is different than the updated dependency endpoint (210) of the updated artifact (208). In an embodiment, the revised dependency endpoint (214) may point to a source control system (224), defined further below. However, the revised dependency endpoint (214) may point to some other system, program, data, or resource, as defined by the owner of the enterprise environment (220).

The data repository (200) may also store a benchmark (216). A benchmark (216) is a definite standard against which performance of a thing may be evaluated. The thing being tested may be the software (202), an artifact (204) (especially the revised artifact (212)), the enterprise environment (220) as a whole, or any other component of the enterprise environment (220) may be compared after the deployment of the revised artifact (212).

For example, the benchmark (216) may be that, when called or referenced, an artifact (204) performs as desired. The benchmark (216) may be that, when executed, a software application that interacts with an artifact (204) performs as desired. The benchmark (216) may be that the enterprise environment (220) produces an expected output when the software (202) with the revised artifact (212) is deployed in a test environment (222) of the enterprise environment (220), as described below. The benchmark (216) could be a value, such as for example, that the software (202) or the enterprise environment (220) performs within a defined time interval (i.e., is “fast enough” to satisfy a software engineer or imposed standard). Thus, the benchmark (216) may take many different forms.

The data repository (200) may include a second software application (218). The second software application (218) is a logically distinct definition of program code relative to the program code which defines the software (202). The second software application (218) may be, for example, another web application for use in the enterprise environment (220). The second software application (218) may be programmed to interact, at least indirectly, with the software (202) when both the software (202) and the second software application (218) are deployed in the enterprise environment (220).

Direct interaction among software programs occurs when a first software program calls on, refers to, or uses the output of a second software program. Indirect interaction among software programs occurs when a first software program calls on, refers to, or uses the output of a third software application that, itself, calls on, refers to, or uses the output of the second software program. The second software application (218) may use any of the artifact (204), the updated artifact (208), or the revised artifact (212), or may interact with some different artifact not described in FIG. 2.

The system shown in FIG. 2 also includes an enterprise environment (220). The enterprise environment (220) hardware and/or software dedicated to performing a set of tasks having a common purpose. For example, an enterprise environment (220) may be hardware and/or software useful for operating an online aspect of a business.

For a specific example, an online store may have many websites showing products for sale, purchase of which may be arranged using electronic transactions performed by the shopper entering transaction data in one of the websites. The hardware and/or software which enables displaying of goods for sale, enables a user to search for products, and performs an electronic transaction to purchase goods, may be the enterprise environment (220). The enterprise environment (220) may include many web applications and many computers, plus routing and communications equipment.

The enterprise environment (220) may include a test environment (222). The test environment (222) is a logically compartmentalized portion of the enterprise environment (220). The test environment (222) may also be referred to as a “sandbox,” an “integrated development environment,” or other terms known in the art. Because the test environment (222) is logically compartmentalized from the rest of the enterprise environment (220), web applications, computer configurations, artifacts, software, etc. may be tested in the context of the enterprise environment (220) without causing unexpected behavior in the enterprise environment (220) as a whole.

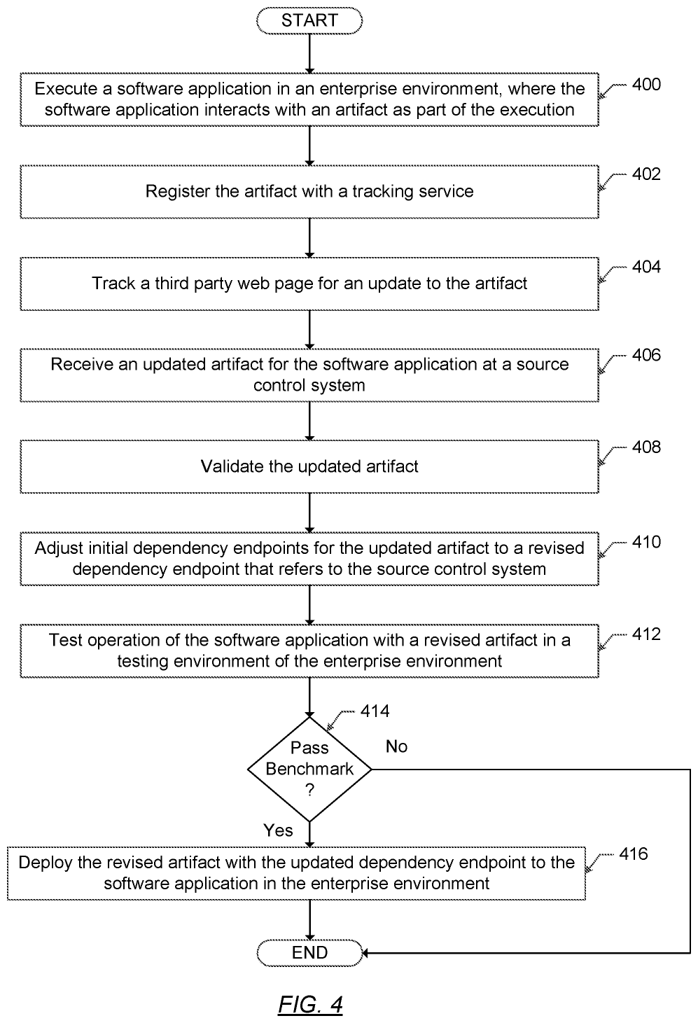

The system shown in FIG. 2 also includes a source control system (224). The source control system (224) is hardware, software, or a combination thereof programmed to manage how updated artifacts are managed prior to deployment in the software (202) or second software application (218) deployed in the enterprise environment (220). The source control system (224) is programmed to carry out the procedures described with respect to FIG. 3 or FIG. 4, for example.

The system shown in FIG. 2 also may include an artifact registration system (226). The artifact registration system (226) is software, hardware, or a combination thereof that is programmed to track and manage multiple artifacts used in the operation of the enterprise environment (220). Thus, for example, the artifact registration system (226) may include a list of all artifacts used in the operation of the enterprise environment (220), including the artifact (204).

The artifact registration system (226) may also be programmed to monitor for new updates to artifacts as the updates become available from third party providers. For example, the artifact registration system (226) may be programmed to poll or monitor at least one of many third party websites for updated artifacts.

The artifact registration system (226) may be programmed to request a download of an updated artifact from a third party website. The artifact registration system (226) may also be programmed to be the receiving endpoint for desired updates when pushed by a third party. In any case, the artifact registration system (226) is programmed to track and possibly obtain and manage updated artifacts from third party providers.

The system shown in FIG. 2 may also include a validation system (228). The validation system (228) is software, hardware, or a combination thereof programmed to validate one or more artifacts after having been received from the third party providers, as described above. The procedures for performing validation are described with respect to FIG. 3 and FIG. 4. In an embodiment, the validation system (228) may be part of the artifact registration system (226).

The system shown in FIG. 2 may also include an updating service (230). The updating service (230) is software, hardware, or a combination thereof programmed to further modify the updated artifact (208) prior to testing. For example, if the owner or operator of the enterprise environment (220) prefers to modify the artifact (204) in some way prior to deployment in the enterprise environment (220), the such modification may be performed by the updating service (230).

The third party system (232) may not be part of the system shown in FIG. 2, and thus is labeled as external (i.e., outside the rest of the system shown in FIG. 2). However, the third party system (232) could be part of the system shown in FIG. 2. For example, the owner or operator of the enterprise environment (220) may hire the third party to participate in the system shown in FIG. 2, or may own or operate the third party system (232) itself. The third party system (232) may include many artifacts (234). The third party system (232) may include updated artifacts (236) which ultimately may be pushed to or downloaded by the artifact registration system (226) and/or the data repository (200).

While FIG. 2 shows a configuration of components, other configurations may be used without departing from the scope of the invention. For example, various components may be combined to create a single component. As another example, the functionality performed by a single component may be performed by two or more components.

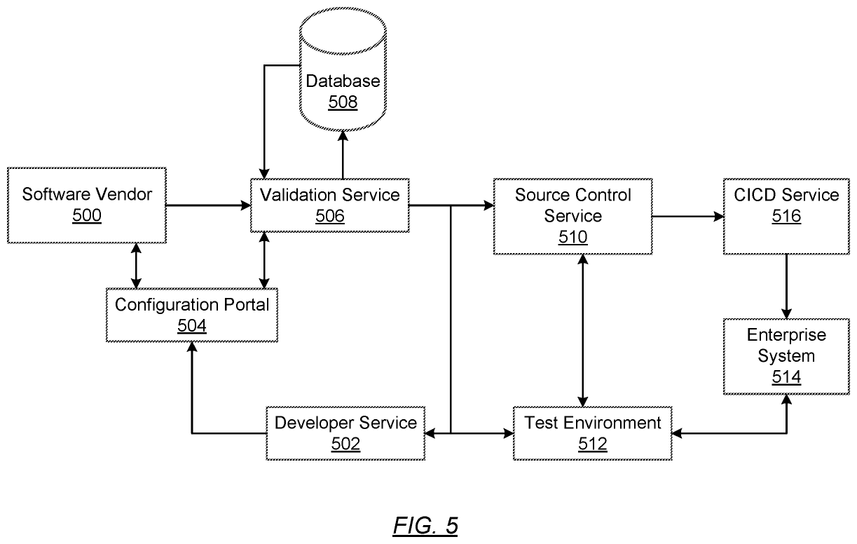

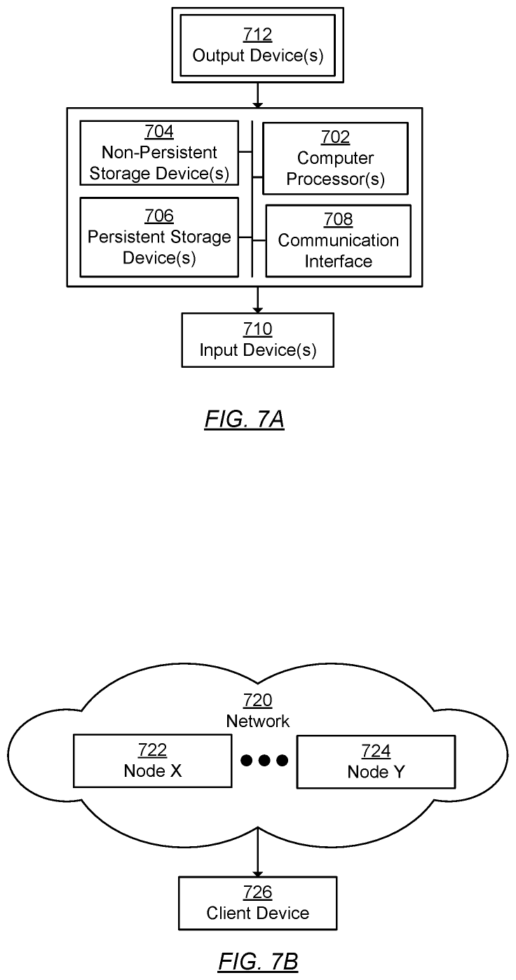

FIG. 3 is a method for preventing unexpected behavior in an enterprise environment due to an update to a third party artifact. The method shown in FIG. 3 may be executed using the system shown in FIG. 2, the system shown in FIG. 5, together with one or more computers in a possibly networked environment as shown in FIG. 7A and FIG. 7B.

At step 300, a software application is executed in an enterprise environment, where the software application interacts with an artifact as part of execution of the software application. For example, the software application could be a program which receives the financial data of a customer to purchase online goods offered for sale by another software application on the enterprise environment. The artifact may be a library to which the software application refers in order to execute the function of the software application.

At step 302, an updated artifact is received for the software application at a source control system. Receipt of the updated artifact may be performed by downloading the update from a third party website. Alternatively, a third party could push the update to the source control system at the request of the owner of the enterprise system.

At step 304, the updated dependency endpoint for the updated artifact is adjusted to revised dependency endpoint that refers to the source control system. Adjustment of the updated dependency endpoint may be accomplished by replacing the updated dependency endpoint in the updated artifact with the revised dependency endpoint. Alternatively, an overriding dependency endpoint may be added to the updated artifact. In still another embodiment, a wrapper may be placed around the updated artifact, with the dependency endpoint of the wrapper pointing to the source control system.

At step 306, a determination is made whether to modify the artifact prior to testing and deployment. Modification may be performed by software or hardware programmed to modify artifacts automatically in some manner. For example, data may be added to or deleted from libraries. Additional information or code may be added to the artifact with respect to specialized aspects of the enterprise system. Modification may also be performed by a developer manually changing the artifact.

Whether or not the artifact is further modified, at step 308, operation of the software application with the revised artifact is tested in a testing environment of the enterprise environment. In particular, at step 310, a determination is made whether the revised artifact with the revised dependency endpoint passes a benchmark. If not, then the method may terminate. Optionally, at a “no” determination at step 308, the method may return to step 306 for additional modification of the revised artifact in an attempt to bring the revised artifact into compliance with the benchmark. Optionally, at a “no” determination at step 308, the method may return to step 302 and a new artifact is downloaded and modified in order to re-attempt the process.

At step 312, assuming a “yes” determination at step 310, the revised artifact with the revised dependency endpoint is deployed to the software application in the enterprise environment. Deployment may be performed by the source control system pushing the revised artifact to the software application, or otherwise causing replacement or revision of the prior artifact that the software application had been using. The method of FIG. 3 may terminate thereafter.

The method of FIG. 3 has a technical usefulness over prior methods for deploying artifacts in an enterprise environment. In particular, the method of FIG. 3 is effective to avoid direct communication between the software application in the enterprise system and the third party. The method of FIG. 3 may also reduce the likelihood of unexpected behavior by the enterprise system.

The method of FIG. 3 may be further modified or extended. For example, assume that the enterprise environment includes the software application and a second software application. In this case, the method may also include executing the second software application in a manner that operation of the revised artifact with the revised dependency endpoint in the software application interacts at least indirectly with the second software application.

In another embodiment, prior to receiving the updated artifact, the method may include receiving registration of the artifact in an artifact registration system in communication with the source control system. In this case, the artifact registration system may track updates to multiple artifacts, including the artifact, from potentially multiple third parties.

For example, the artifact registration system may receive the updated artifact from the third party. The multiple artifacts may include a second artifact from a second third party. In this case, receiving the updated artifact may be performed by the artifact registration system pushing the updated artifact to the source control system.

In another embodiment, the method may also include polling, by the artifact registration system, external web sites of the third parties for updates to the artifacts. Then, responsive to discovering an updated artifact on at least one of the external web sites, a request to receive the updated artifact may be sent to the at least one of the external web sites.

In still another embodiment, the method may also include notifying a developer of the software application that the updated artifact has been received. Thus, if manual review of the updated artifact is desirable, a developer may perform such a review.

In yet another embodiment, the method may also include, after receiving the updated artifact and prior to testing, validating the updated artifact. Validation may be a verification procedure that ensures that the updated artifact received from a third party provider is as intended. For example, a checksum may be used to ensure that a downloaded updated artifact is free of errors that might arise during the downloading process. In another example, a hash may be used to determine changes between the prior artifact and the updated artifact.

In yet another example, validation may be performed by testing the artifact in a context other than the enterprise environment or the test environment to ensure that the updated artifact performs as expected, is free of errors, and/or is not malicious. Validation may also be performed by a developer manually confirming that the updated artifact is correct. Once the artifact is successfully validated, the updated artifact may be received at or pushed to the source control system.

FIG. 4 is another method for preventing unexpected behavior in an enterprise environment due to an update to a third party artifact. The method shown in FIG. 4 may be executed using the system shown in FIG. 2, the system shown in FIG. 5, together with one or more computers in a possibly networked environment as shown in FIG. 7A and FIG. 7B. The method shown in FIG. 4 may be a variation of the method described with respect to FIG. 3.

At step 400, a software application is executed in an enterprise environment, where the software application interacts with an artifact as part of execution of the software application, as described with respect to step 300 of FIG. 3. However, in this method, at step 402, the artifact is registered with a tracking service. Registration may be performed by software or hardware that monitors software for the presence of artifacts, and then automatically registers an artifact that has been detected. Registration also may be performed by a developer adding the artifact to an artifact registration system.

At step 404, a third party web page is tracked for an update to the artifact. For example, the web page may be monitored for when a new artifact version appears. The web page also may be monitored for an announcement of the release of a new artifact version.

At step 406, responsive to identifying the update, an updated artifact for the software application may be received at a source control system. Receipt may be accomplished by pushing the updated artifact to the source control system, or by the source control system pulling the updated artifact from the website.

The updated artifact has an updated dependency endpoint, which may or may not be the same as the original dependency endpoint. However, it is assumed that the updated dependency endpoint will be further adjusted, as described further below.

At step 408, the updated artifact is validated. Validation may be performed as described with respect to the validation processed described as optional in FIG. 3.

At step 410, responsive to validating, the initial dependency endpoints for the updated artifact may be adjusted to a revised dependency endpoint that refers to the source control system. Adjusting may be performed as described with respect to step 304 in FIG. 3.

At step 412, operation of the software application with the revised artifact may be tested in a testing environment of the enterprise environment. Testing may be performed as described with respect to step 308 in FIG. 3.

At step 414, a determination is made whether the operation of the software application with the revised artifact passes a benchmark. Alternatively, step 414 could be a determination of whether the enterprise environment as a whole is predicted to behave as expected when the revised artifact is deployed to the test environment of the enterprise environment. If the benchmark is failed, then the method may terminate, or may be repeated starting with re-downloading the updated artifact at step 406.

However, if the benchmark is passed, then at step 416, responsive to testing passing the benchmark, the revised artifact with the revised dependency endpoint is deployed to the software application in the enterprise environment. Deployment may be performed as described with respect to step 312 of FIG. 3. The method of FIG. 4 may terminate thereafter.

The method of FIG. 4 may be further modified. For example, several of the variations described with respect to FIG. 3 may also be applied to the method of FIG. 4.

While the various steps in FIG. 3 and FIG. 4 are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

FIG. 5 is another system for preventing unexpected behavior in an enterprise environment due to an update to a third party artifact. Thus, FIG. 5 is a variation of the system shown in FIG. 2.

In general, FIG. 5 shows a system that monitors changes in third party artifacts at their source (i.e., the third party systems such as a content delivery network (CDN) or a continuous integration, continuous deliver (CICD) system). The software vendor (500) is a CDN or web host which maintains and periodically presents updates to artifacts or perhaps new artifacts.

In this example, a developer service (502) is provided. The developer service (502) is software, hardware, or a combination thereof programmed to manage the rest of the system shown in FIG. 5. The developer service (502) may be monitored or operated by developers, such as computer programmers or technicians. The developer service (502) may present, for example, a dashboard for use by a developer in managing the system shown in FIG. 5.

The developer service (502) may include a configuration portal (504). The configuration portal (504) may be used to register artifacts for tracking changes to the artifacts, and to change how and when artifacts are downloaded or received, and how or when artifacts are validated.

Then, when the software vendor (500) pushes or makes available an updated artifact, a validation service (506) may initially receive the updated artifact. The validation service (506) may perform a variety of validation procedures. The uniform resource locator (URL) of the updated artifact may be verified to ensure that the URL is from a trusted source. The scheduling of updates to the artifacts may be verified. A checksum or hash may be used to ensure that downloading of the updated artifact has been accomplished free of errors. A checksum and/or a hash may also be used to compare the updated artifact to a prior version of the artifact to determine whether there were any changes to the prior version of the artifact. The dependencies of the artifacts may be verified.

The information being checked, including the updated artifact and possibly prior versions of artifacts, may be stored in a database (508). The database (508) store various configurations of the artifacts, the software, prior test results, or any of the other information described above. The database (508) may also store a list of artifacts to be tracked by the developer service (502) and/or the validation service (506).

If changes are identified, then the updated artifact may be pushed to or pulled by a source control service (510). The source control service (510) may adjust dependency endpoints of the updated artifact to local (e.g. the source control service (510) or perhaps a computer in the developer service (502)). Optionally, a notification of this event may be sent to the developer service (502). Optionally, again, a developer or automatic process may further revise the artifact using the developer service (502). For example, customized computer code may be desirably added to third party computer code, bug fixes may be applied to the third party artifact, or other changes may be made. In any case, a revised artifact is generated with local endpoints is generated and available to the source control service (510).

The revised artifact is now ready for testing to reduce the likelihood that deployment of the revised artifact will cause unexpected behavior. For example, the developer service (502) may cause the deployment of the revised artifact to a test environment (512). The test environment (512) may be a stand-alone environment in which to test the revised artifact, or the test environment (512) may be an integrated development environment (IDE) within an enterprise system (514). Testing may be performed automatically to see how the artifact and/or software that interacts with the artifact behaves in the enterprise system (514). The behavior of the enterprise system (514) as a whole may also be tested in the test environment (512). Optionally, testing may be manually performed by a developer using the developer service (502).

Testing may be performed by comparing the results of testing to a benchmark. The benchmark may be as described above with respect to FIG. 2 through FIG. 4.

Once testing is complete and the revised artifact is deemed satisfactory, the revised artifact may be pulled by (or pushed to) the source control service (510) to a continuous integration/continuous delivery system, which may be referred to as a CICD service (516). The CICD service (516) may perform continuous integration jobs, including additional automatic tests and scans, if desirable. The CICD service (516) also deploys the revised artifact to one or more web applications or other aspects of the enterprise system (514).

In another, more specific, example of the CICD service (516) in use, a developer may use a tool like Veracode to perform code analysis on client-side code, like Cross-Site Scripting (XSS) or Cross-Site Request Forgery (CSRF). The developer could also perform code quality scans using tools like SonarQube or DeepScan, for example, to find otherwise unreachable code, perform inconsistent null checks, etc. The developer could run a tool like Selenium or Cypress for automated tests to help ensure the software being deployed to the enterprise system (514) is not broken due to third party changes to the artifact. A developer could also run a tool like WebPageTest to help ensure that a third party change to an artifact does not degrade performance of the software once deployed to the enterprise system (514). Many other examples are possible.

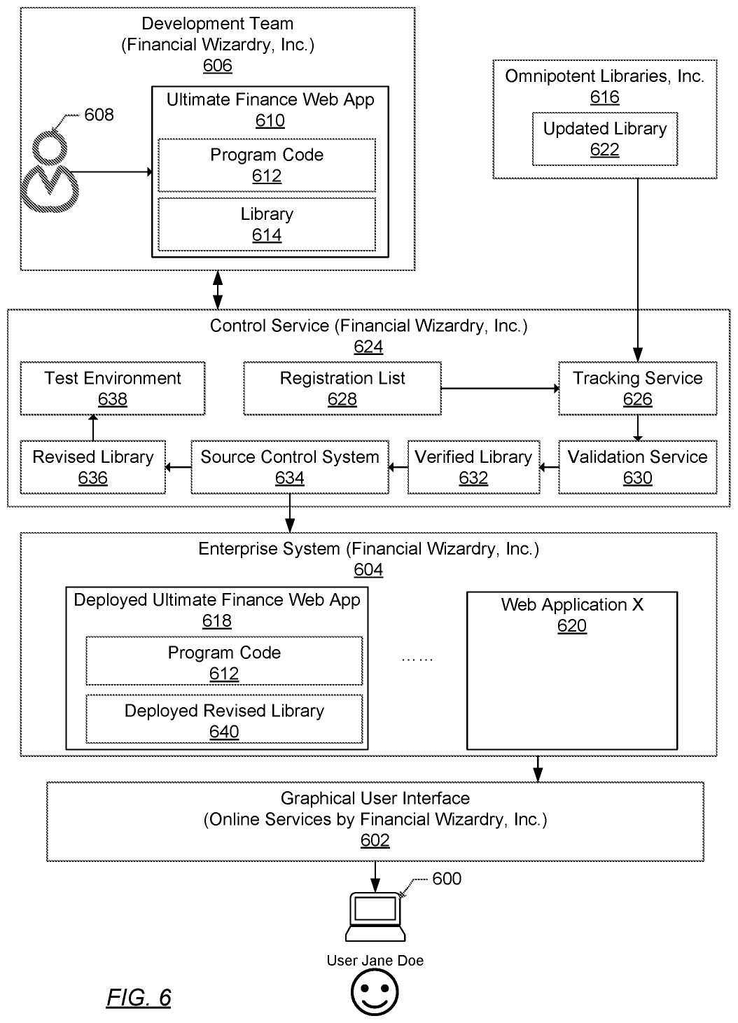

FIG. 6 is an example of preventing unexpected behavior in an enterprise environment due to an update to a third party artifact. The following example is for explanatory purposes only and not intended to limit the scope of the invention.

In the example of FIG. 6, a user, Jane Doe, uses a remote computer (600) to interact with a graphical user interface (602) to utilize the service of the enterprise system (604) owned and maintained by a company named “Financial Wizardry, Inc.” Financial Wizardry, Inc. provides financial management services, such as an online financial management system that allows Jane Doe to track her personal finances.

In this example, Jane Doe is not the only user of the enterprise system (604). In fact, there are millions of additional users and remote computers that interact with the enterprise system (604). The services provide by the enterprise system (604) are supplied by tens of thousands of web applications and thousands of computers, which together enable the remote computer (600), and others like it, to access and use the graphical user interface (602). Thus, in this example, the enterprise system (604) is a large scale enterprise, as one of skill in the art would understand the term “large scale.”

However, as described above, maintaining the enterprise system (604) is a difficult task because the enterprise system (604) is large scale. Thus, automatic updating of artifacts for the various web applications that partially form the enterprise system (604) is required in this particular example.

In this example, a development team (606) of Financial Wizardry, Inc. is responsible for creating web applications used by the enterprise system (604). In this example, a developer (608) generates a particular web application named Ultimate Finance Web App (610). The Ultimate Finance Web App (610) includes program code (612) for executing some function within the enterprise system (604). For example, the program code (612) may instructions for the remote computer (600) to display the graphical user interface (602) to Jane Doe. The Ultimate Finance Web App (610) includes a specific kind of artifact, library (614). The library (614) contains reference data used by the program code (612) during execution in order to properly generate the graphical user interface (602).

The library (614) was not written by the developer (608), but rather was written and maintained by a company entirely different than Financial Wizardry, Inc. In particular, in this example, Omnipotent Libraries, Inc. (616) maintains a website where the library (614) may be obtained by many different programmers, such as developer (608) at Financial Wizardry, Inc. The developer (608) previously obtained the library (614) during the process of generating the Ultimate Finance Web App (610).

After suitable testing and approvals, the Ultimate Finance Web App (610) was deployed to the enterprise system (604). For clarity of reference, this web application is now referred to as the Deployed Ultimate Finance Web App (618). Thus, the enterprise system (604) executes the Deployed Ultimate Finance Web App (618).

The enterprise system (604) also executes many different web applications, up to and including web application X (620). In this example, the Deployed Ultimate Finance Web App (618) interacts with the web application X (620). In particular, the web application X (620) uses the output of the Deployed Ultimate Finance Web App (618). Thus, the behavior of the Deployed Ultimate Finance Web App (618) may affect the behavior of the web application X (620) and of the enterprise system (604) as a whole.

In this example, Omnipotent Libraries, Inc. (616) updates the library (614) for security reasons, to prevent a security vulnerability Omnipotent Libraries, Inc. (616) detected and corrected on its own initiative. Thus, Omnipotent Libraries, Inc. (616) generates an updated library (622). The updated library (622) is an updated artifact.

Note that, in a variation, the updated library (622) may have been generated outside of Omnipotent Libraries, Inc. (616) by a stranger. The stranger may have been a malicious actor seeking to steal information regarding the financial accounts of Jane Doe, and users like her, from the enterprise system (604). The procedures described herein will reduce the likelihood of such as scheme from working as intended, at least by changing the dependency endpoints of the updated library (622).

In the example of FIG. 6, Financial Wizardry, Inc. maintains a control service (624). The control service (624) is used to maintain control of updates to artifacts, including the updated library (622).

In this example, a tracking service (626) of the control service (624) monitors the websites or web hosts of Omnipotent Libraries, Inc. (616) for updates to artifacts listed in a registration list (628). Previously, the developer (608) had caused the library (614) to be added to the registration list (628). By monitoring for updates to the artifacts in the registration list (628), the tracking service (626) detects when updated library (622) becomes available on the web host maintained by Omnipotent Libraries, Inc. (616).

The tracking service (626) then causes a validation service (630) to download the updated library (622). The validation service (630) verifies that the download is accurate and further checks for changes present in the updated library (622) relative to the library (614) via a hash check. Once the validation service (630) has completed these tasks, the verified library (632) is provided to a source control system (634).

The source control system (634) changes the endpoints of the verified library (632) to refer to the source control system (634). In this manner, the resulting revised library (636) must refer to the source control system (634) and not to some outside entity, like Omnipotent Libraries, Inc. (616). Note that Omnipotent Libraries, Inc. (616) may be a trusted partner of Financial Wizardry, Inc. However, such a fact does not alter the possibility of unintended behavior in the enterprise system (604) that may be caused by the updated library (622) if deployed in an uncontrolled manner to the enterprise system (604). Optionally, the revised library (636) may include additional changes to the updated library (622), if considered desirable or necessary by the developer (608).

The revised library (636), and/or the Ultimate Finance Web App (610) together with the revised library (636), is then tested in a test environment (638). The test environment (638) is an integrated development environment of the enterprise system (604). Thus, the operation of the Ultimate Finance Web App (610) with the revised library (636) may be tested with respect to the enterprise system (604) as a whole without impacting or changing the operation of the enterprise system (604) with respect to users like Jane Doe. Testing is performed against a benchmark.

In this example, because the Ultimate Finance Web App (610) is intended to furnish the graphical user interface (602), a check is made to ensure that no unexpected changes to the graphical user interface (602) occur when the Ultimate Finance Web App (610) is used with the revised library (636). Thus, the benchmark is “the Ultimate Finance Web App (610) with the revised library (636) behaves the same as the Deployed Ultimate Finance Web App (618) with the prior version of the library (614).” However, other benchmarks are possible. For example, a verification may be made that the web application X (620) behaves as expected when it receives the output of the Deployed Ultimate Finance Web App (618) with the revised library (636).

Once the revised library (636) has been tested and verified to be satisfactory against one or more benchmarks, the source control system (634) deploys the revised library (636) to the enterprise system (604). In particular, the Deployed Ultimate Finance Web App (618) is modified to include or reference the deployed revised library (640). The deployed revised library (640) is the revised library (636), after deployment to the actual enterprise system (604) with which the remote computer (600) interacts. In an embodiment, the deployed revised library (640) is maintained in the control service (624) or the source control system (634), and referenced by the Deployed Ultimate Finance Web App (618).

Thus, the control service (624) described with respect to FIG. 6 ensures separation between Omnipotent Libraries, Inc. (616) and the enterprise system (604) of Financial Wizardry, Inc. The separation increases the security of the enterprise system (604). The control service (624) also ensures that updates by Omnipotent Libraries, Inc. (616) are deployed in a secure, controlled, and verified manner. Thus, Jane Doe is less likely to experience frustrations caused by unexpected behavior of the enterprise system (604) that could result if the updated library (622) were used by the Deployed Ultimate Finance Web App (618) without controls.

Embodiments of the invention may be implemented on a computing system. Any combination of mobile, desktop, server, router, switch, embedded device, or other types of hardware may be used. For example, as shown in FIG. 7A, the computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities.

The computer processor(s) (702) may be an integrated circuit for processing instructions. For example, the computer processor(s) may be one or more cores or micro-cores of a processor. The computing system (700) may also include one or more input devices (710), such as a touchscreen, keyboard, mouse, microphone, touchpad, electronic pen, or any other type of input device.

The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the computing system (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (700) may be located at a remote location and connected to the other elements over a network.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system shown in FIG. 7A. Further, the client device (726) may include and/or perform all or a portion of one or more embodiments of the invention.

The computing system or group of computing systems described in FIGS. 7A and 7B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 7A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 7A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 7A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 7A and the nodes and/or client device in FIG. 7B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
executing a software application in an enterprise environment, wherein the software application interacts with an artifact as part of execution of the software application;
receiving an updated artifact for the software application at a source control system, wherein:
the updated artifact comprises an updated dependency endpoint, and
the updated artifact is published by a third party;
adjusting the updated dependency endpoint for the updated artifact to a revised dependency endpoint that refers to the source control system;
testing operation of the software application with the revised artifact in a testing environment for the enterprise environment,
wherein the revised artifact has the revised dependency endpoint during testing, and
wherein testing is performed against a benchmark;
deploying, responsive to testing passing the benchmark, the revised artifact with the revised dependency endpoint to the software application in the enterprise environment.

2. The method of claim 1, wherein direct communication is avoided between the software application in the enterprise system and the third party.

3. The method of claim 1, wherein the enterprise environment comprises the software application and a second software application, and wherein the method further comprises:
executing the second software application in a manner that operation of the revised artifact with the revised dependency endpoint in the software application interacts at least indirectly with the second software application.

4. The method of claim 1, further comprising:
prior to receiving the updated artifact, receiving in an artifact registration system in communication with the source control system, registration of the artifact;
tracking, by the artifact registration system, updates to a plurality of artifacts, including the artifact, from a plurality of third parties, including the third party.

5. The method of claim 4, wherein:
the artifact registration system receives the updated artifact from the third party,
the plurality of artifacts include a second artifact from a second third party, and
receiving the updated artifact is performed by the artifact registration system pushing the updated artifact to the source control system.

6. The method of claim 4, further comprising:
polling, by the artifact registration system, a plurality of external web sites of the plurality of third parties for updates to the plurality of artifacts.

7. The method of claim 6, further comprising:
responsive to discovering the updated artifact on at least one of the plurality of external web sites, sending a request to receive the updated artifact.

8. The method of claim 1, further comprising:
prior to testing, modifying the artifact.

9. The method of claim 1, further comprising:
notifying a developer of the software application that the updated artifact has been received.

10. The method of claim 1, further comprising:
after receiving the updated artifact and prior to testing, validating the updated artifact;
responsive to a successful validation, performing receiving of the updated artifact.

11. A system comprising:
a data repository storing:
an artifact with which a software application is programmed to interact, wherein the artifact comprises an initial dependency endpoint,
an updated artifact, having an updated dependency endpoint, received from a third party,
a revised artifact comprising the updated artifact having a revised dependency endpoint,
a benchmark; and
an enterprise environment in which the software application is executable; and
a source control system configured to:
receive the updated artifact at the source control system,
adjust the updated dependency endpoint to the revised dependency endpoint to point to the source control system, in order to form the revised artifact,
test operation of the software application with the revised artifact in a testing environment for the enterprise environment, and
deploy, responsive to testing passing the benchmark, the revised artifact to the software application in the enterprise environment.

12. The system of claim 11, wherein:
the data repository stores a second software application executable in the enterprise environment, and
the second software application is programmed to interact at least indirectly with the software application in an enterprise environment,

13. The system of claim 11, further comprising:
an artifact registration system, configured to:
receive registration of the artifact, and
track updates to a plurality of artifacts, including the artifact, on a plurality of websites of a plurality of third parties, including the third party.

14. The system of claim 13, wherein the artifact registration system is further configured to:
poll at least one of the plurality of websites for the updated artifact, and
responsive to discovering the updated artifact, send a request to receive the updated artifact.

15. The system of claim 13, further comprising:
a validation system configured to validate the updated artifact prior to adjusting.

16. The system of claim 10, further comprising:
an updating service configured to further modify the updated artifact prior to testing.

17. A method comprising:
executing a software application in an enterprise environment, wherein the software application interacts with an artifact as part of execution of the software application;
registering the artifact with a tracking service;
tracking a third party web page for an update to the artifact published by a third party;
receiving, responsive to identifying the update, an updated artifact for the software application, wherein the updated artifact comprises an updated dependency endpoint;
validating the updated artifact;
adjusting, responsive to validating, the updated dependency endpoint for the updated artifact to a revised dependency endpoint that refers to a source control system;
testing operation of the software application with the revised artifact in a testing environment for the enterprise environment,
wherein the revised artifact has the revised dependency endpoint during testing, and
wherein testing is performed against a benchmark; and
deploying, responsive to testing passing the benchmark, the revised artifact with the revised dependency endpoint to the software application in the enterprise environment.

18. The method of claim 17, wherein direct communication is avoided between the software application in the enterprise system and the third party.

19. The method of claim 17,
wherein the enterprise environment comprises the software application and a second software application, and
wherein the method further comprises executing the second software application in a manner that operation of the revised artifact with the revised dependency endpoint in the software application interacts at least indirectly with the second software application.

20. The method of claim 17, further comprising:
prior to testing, automatically modifying the artifact.
